(19) United States
(12) Patent Application Publication
(10) Pub. No.: US 2018/0314353 A1
(43) Pub. Date: Nov. 1, 2018

(54) ELECTRONIC DEVICE AND OPERATING METHOD THEREOF

(71) Applicant: Chiun Mai Communication Systems, Inc., New Taipei (TW)

(72) Inventor: CHIH-MIN CHAN, New Taipei (TW)

(21) Appl. No.: 15/885,921

(22) Filed: Feb. 1, 2018

(30) Foreign Application Priority Data
Apr. 26, 2017 (CN) 201710281181.3

(51) Int. Cl. G06F 3/0354; G06F 3/14; G06F 3/0488; G09G 5/12

(52) U.S. Cl. CPC G06F 3/03547; G06F 3/1423; G06F 3/04886; G09G 2370/06; G09G 2354/00; G09G 2370/16; G09G 5/12

(57) ABSTRACT

An electronic device in wireless communication with an external display includes an electronic paper and a touch module. The touch module receives at least one touch operation to trigger the external display to display a first control item and the electronic paper to display a virtual keyboard. The touch module receives input operations through the virtual keyboard, and controls the external display to display information on the first control item. An operating method of the electronic device in wireless communication with the external display is also provided.

### FIELD

The subject matter herein generally relates to an electronic device, especially relates to an electronic device and an operating method for an external display connecting to the electronic device.

### BACKGROUND

Most portable electronic devices nowadays have small displays, which typically have worse visual user experience than displays of laptops or tablet computers. However, when the electronic device connects to an external display and offers user interface to the external display, but at the same time an external input device is needed for the external display, user experience may not be good.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is a block diagram of a first type of an electronic device.

FIG. 2 is a disassembled perspective view of the first type of the electronic device.

FIG. 3 is a diagram of one exemplary embodiment of a user interface for a display.

FIG. 4 is a block diagram of a second type of an electronic device.

FIG. 5 is an isometric view of the second type of the electronic device and a case of the electronic device.

FIG. 6 is an isometric view of a third type of electronic device and a case.

FIG. 7 is a flow chart of a first embodiment of an operating method of an electronic device connected to an external display.

FIG. 8 is a schematic diagram of an electronic paper of an electronic device displaying a second controlling item.

FIG. 9 is a flow chart of a second embodiment of an operating method of an electronic device connected to an external display.

FIG. 10 is a block diagram of a fourth type of an electronic device.

FIG. 11 is an isometric view of the fourth type of the electronic device.

FIG. 12 is an isometric view of a fifth type of an electronic device.

FIG. 13 is a flow chart of a third embodiment of an operating method of an electronic device connected to an external display.

FIG. 14 is a flow chart of a fourth embodiment of an operating method of an electronic device connected to an external display.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

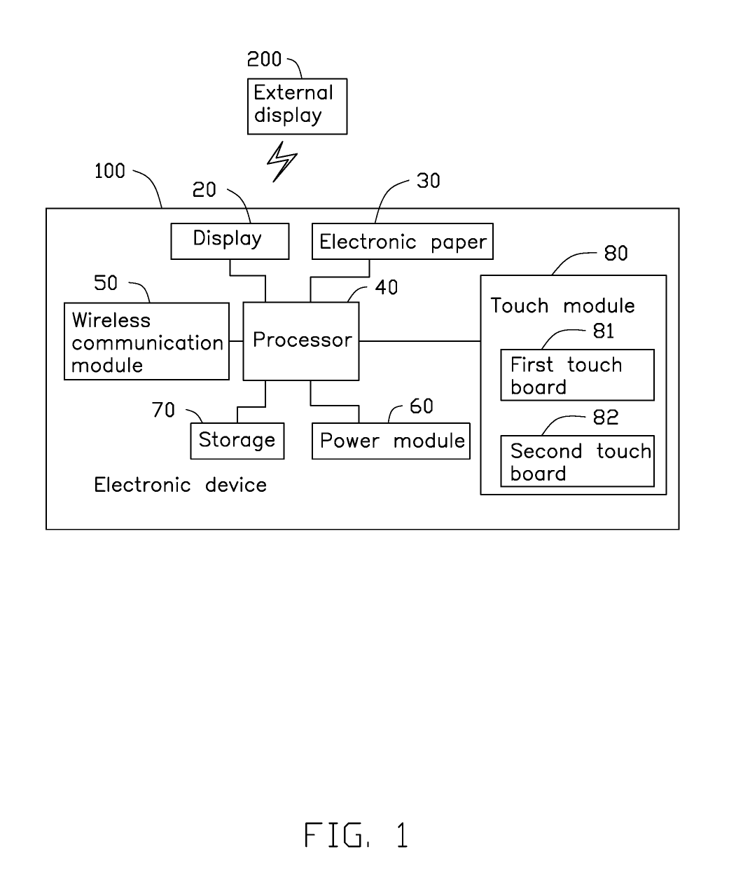

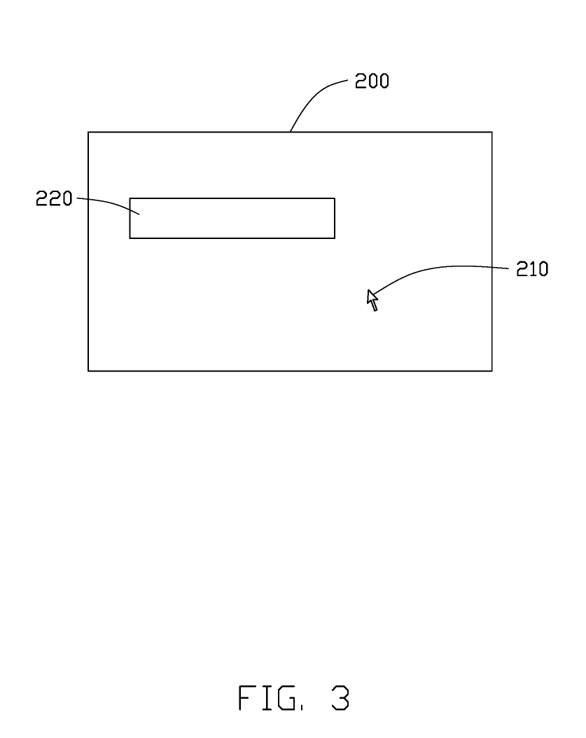

FIG. 1 illustrates a first type of an electronic device (electronic device 100). The electronic device 100 can be, but is not limited to, a mobile phone, a personal digital assistant, or a tablet computer. The electronic device 100 may be connected to an external display 200, and the external display 200 may display a user interface received from the electronic device 100. The external display 200 may further display a first control item 220 (shown in FIG. 3). The first control item 220 can be a text box.

The electronic device 100 includes a display 20, an electronic paper 30, a processor 40, a wireless communication module 50, a power module 60, a storage 70, and a touch module 80. The touch module 80 includes a first touch board 81 and a second touch board 82. The display 20 may combine the first touch board 81 to form a touch display, and the electronic paper 30 may combine the second touch board 82 to form a touch electronic paper. The touch module 80 is configured to receive operation signals of touches or input operations from a user. The processor 40 is configured to process the operation signals or input operations. The wireless communication module 50 is configured to establish a wireless communication with the external display 200 and transmit the operation signals or input operations received by the touch module 80 to the external display 200. The power module 60 and the storage 70 are configured to provide power and storage for the electronic device 100.

In general, the word “module,” as used herein, refers to logic embodied in hardware or firmware, or to a collection of software instructions, written in a programming language, such as, Java, C, or assembly. One or more software instructions in the modules may be embedded in firmware, such as erasable-programmable read-only memory (EPROM). The modules described herein may be implemented as either software and/or hardware modules and may be stored in any type of computer-readable medium or other storage device.

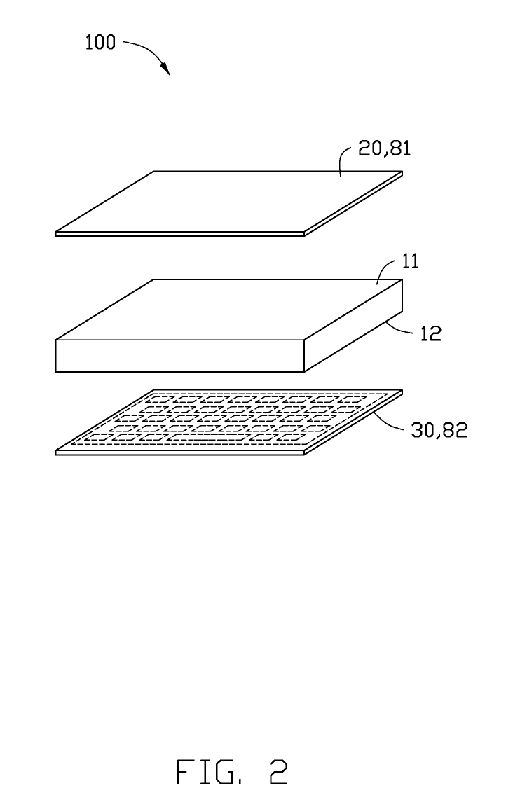

Referring to FIGS. 2 and 3, the electronic device 100 includes a first surface 11 and a second surface 12 opposite to the first surface 11. The display 20 and the first touch board 81 are arranged on the first surface 11, and the electronic paper 30 and the second touch board 82 are arranged on the second surface 12. The electronic device 100 may control an interface of the external display 200 through the display 20, the electronic paper 30, and the touch module 80. In at least one embodiment, the external display 200 is bigger than the electronic device 100 in size, and the external display 200 provides a better display effect, which is good for being viewed by the user. The external display 200 may display a cursor 210 and a text box 220. The electronic paper 30 displays a virtual keyboard for receiving input operation from the user from the second touch board 82. In at least one embodiment, when the electronic device 100 is not in communication with the external display 200, the display 20 is turned on and displays a user interface of the electronic device 100. When the electronic device 100 establishes a wireless communication with the external display 200, the display 20 is turned off.

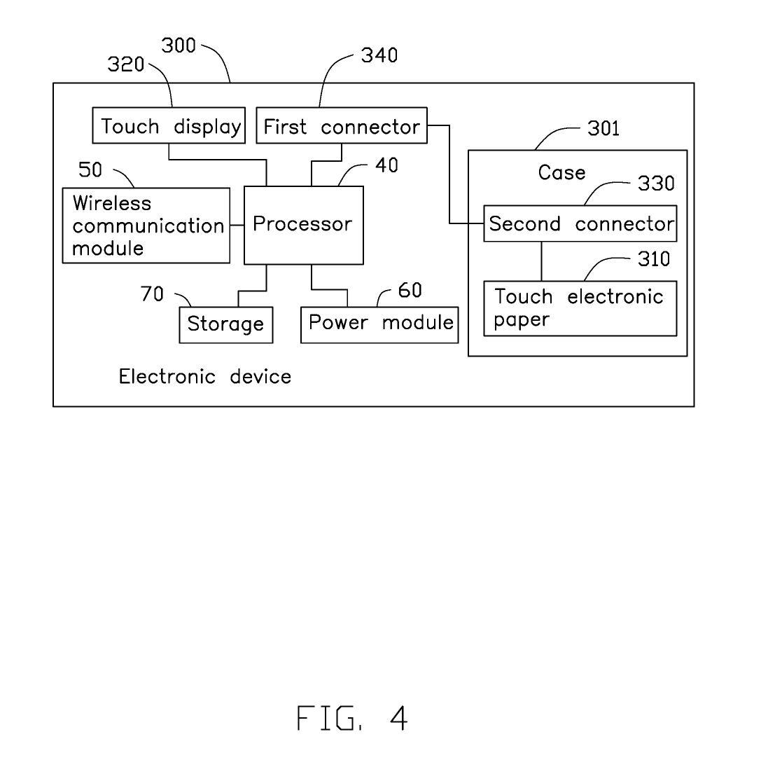

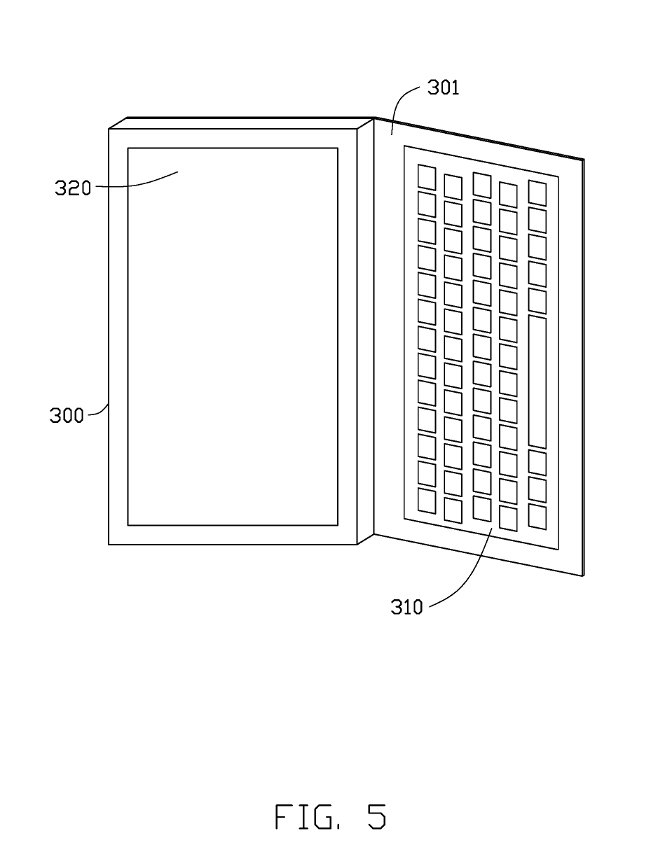

FIGS. 4 and 5 illustrate a second type of electronic device 300. The electronic device 300 includes a case 301. A touch display 320 is arranged on a first surface of the electronic device 300. The case 301 includes a second surface, and a touch electronic paper 310 is arranged on the second surface. The case 301 can be, but is not limited to, a leather case, and detachably cover the electronic device 300. The touch electronic paper 310 is corresponding to the touch display 320. When the case 301 is in a closed state, the touch electronic paper 310 correspondingly covers on the touch display 320. When the case 301 is in an open state, the touch electronic paper 310 can be unfolded to a position adjacent to or opposite to the touch display 320; for example, the touch electronic paper 310 can be unfolded to the back of the electronic device 300. The electronic device 300 further includes a first connector 340, and the case 301 includes a second connector 330. The touch electronic paper 310 may transmit operation signals to the processor 40 when the second connector 330 is connected to the first connector 340. The electronic device 300 is detachably coupled to the case 301 having the touch electronic paper 310; thus, the case 310 can be adapted to different types of electronic device.

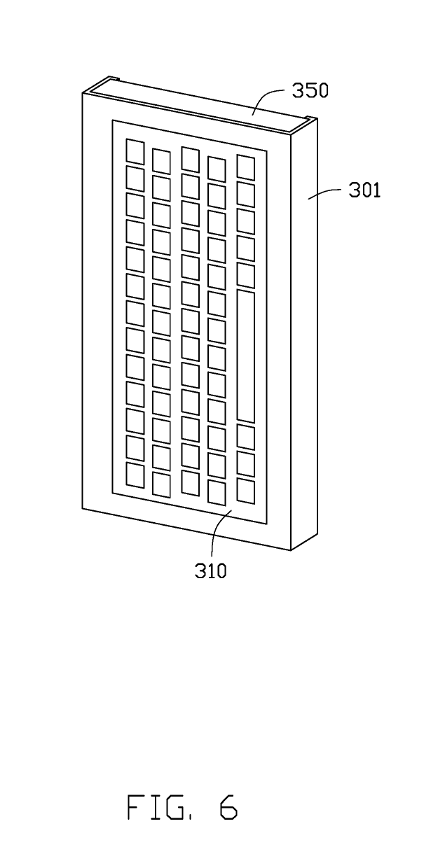

FIG. 6 illustrates a third type of electronic device 350 with a case 301 functioning as a back case and being coupled to the back of the electronic device 350. The touch electronic paper 310 is arranged on a second surface of the case 301 and faces outwards.

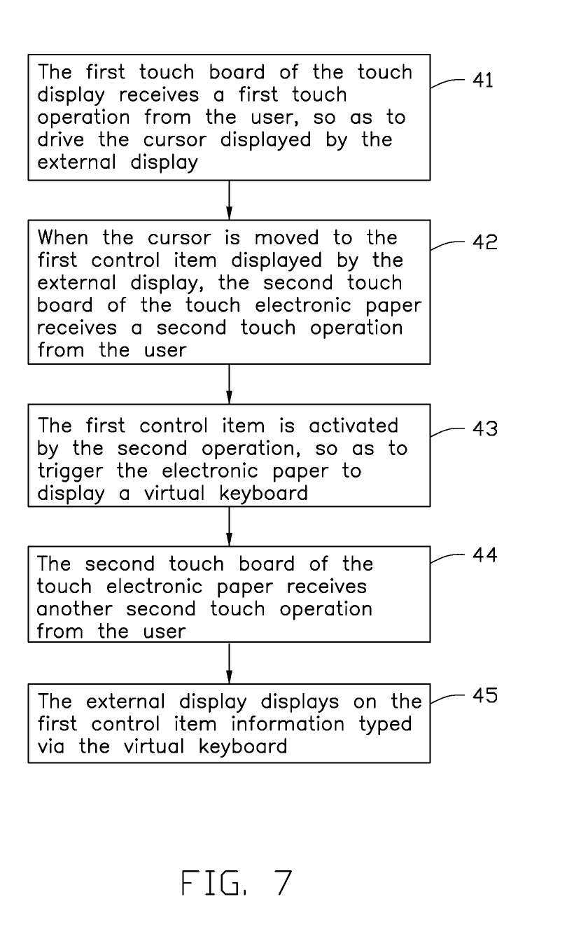

Referring to FIG. 7, a flowchart is presented in accordance with a first embodiment of an operating method of the electronic device 100, 300 or 350 connected to the external display 200. The operating method of the electronic device 100, 300, or 350 can be carried out using the configurations illustrated in FIGS. 1-6, for example, and various elements of these figures are referenced in example method. Each block shown in FIG. 7 represents one or more processes, methods or subroutines, carried out in the exemplary method. Furthermore, the illustrated order of blocks is by example only and the order of the blocks can change according to the present disclosure. Additional blocks may be added or fewer blocks may be utilized, without departing from this disclosure. The exemplary method can begin at block 41.

At block 41, the first touch board 81 of the touch display receives a first touch operation from the user, so as to drive the cursor 210 displayed by the external display 200. The processor 40 and the wireless communication module 50 transmit the first touch operation to the external display 200, so as to drive the cursor 210.

At block 42, when the cursor 210 is moved to the first control item displayed by the external display 200, the second touch board 82 of the touch electronic paper receives a second touch operation from the user. In at least one embodiment, the first control item is a text box 220, the first touch operation includes at least one movement detected by the first touch board 81, and the second touch operation includes at least one click detected by the second touch board 82.

At block 43, the first control item is activated by the second operation, so as to trigger the electronic paper 30 to display a virtual keyboard.

At block 44, the second touch board 82 of the touch electronic paper receives another second touch operation from the user. In at least one embodiment, the another second operation includes typing on the virtual keyboard.

At block 45, the external display 200 displays on the first control item information typed via the virtual keyboard.

In at least one embodiment, the touch display combined by the display 20 and the first touch board 81 and the touch electronic paper combined by the electronic paper 30 and the second control board 82 are arranged on two opposite surfaces of the electronic device 100, 300 or 350, so that the electronic device 100, 300 or 350 is conveniently held by one hand of the user and easily operated on the first surface 11 and the second surface 12 by fingers of the user.

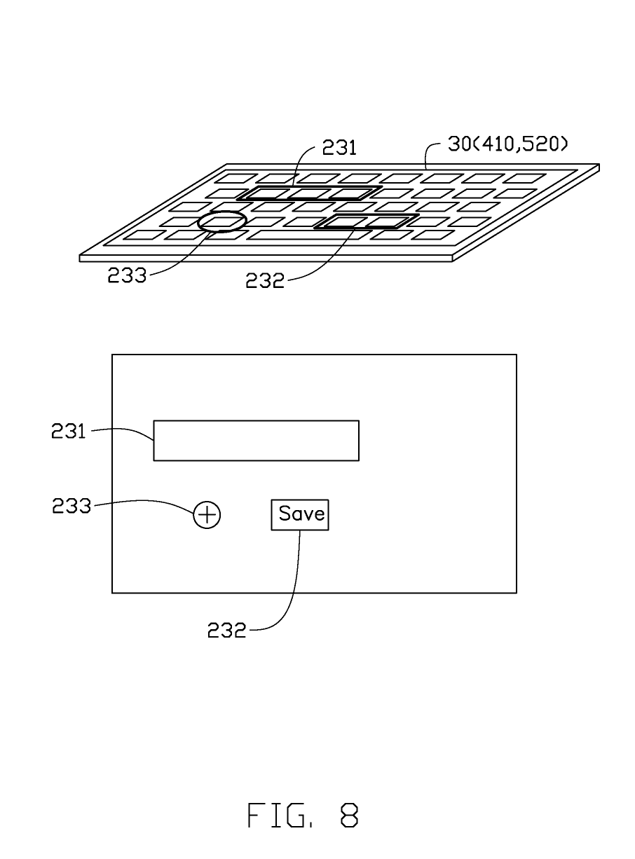

Referring to FIG. 8, the electronic paper 30, 310 of the electronic device 100, 300, 350 may further display a second control item. Specifically, the second control item includes a first control area 231, a second control area 232, and a third control area 233. The first control area 231 is an input control item.

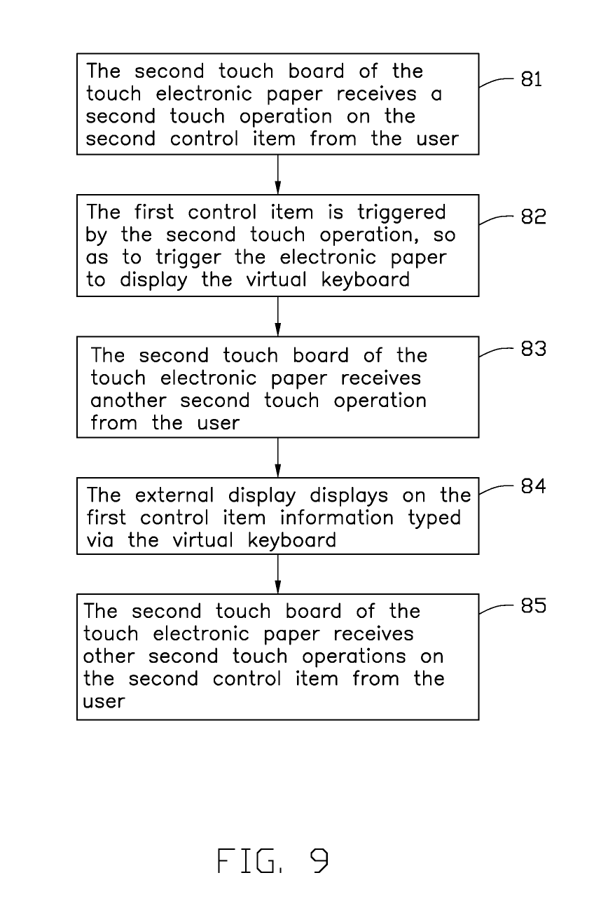

Referring to FIG. 9, a flowchart is presented in accordance with a second embodiment of an operating method of the electronic device 100, 300 or 350 connected to the external display 200.

At block 81, the second touch board 82 of the touch electronic paper receives a second touch operation on the second control item from the user. In at least one embodiment, the second touch operation includes at least one click on the first control area 231. It should be known that, the first touch board 81 is inactivate and does not receive any touch operation from the user.

At block 82, the first control item is triggered by the second touch operation, so as to trigger the electronic paper 30 to display the virtual keyboard.

At block 83, the second touch board 82 of the touch electronic paper receives another second touch operation from the user. The another second touch operation includes typing on the virtual keyboard.

At block 84, the external display 200 displays on the first control item information typed via the virtual keyboard. In at least one embodiment, when the information typed on the first control item is finished, a key of “Esc” or a key of “Enter” on the virtual keyboard can be clicked to leave the first control item.

At block 85, the second touch board 82 of the touch electronic paper receives other second touch operations on the second control item from the user. In at least one embodiment, the second touch board 82 of the touch electronic paper receives other second touch operations on the first control area 231, the second control area 232, and the third control area 233. The other second touch operations include clicks.

In at least one embodiment, the second touch board 82 receives click operations on the first control area 231 to input information via the virtual keyboard. The second control area 232 is a save control item configured to trigger save function. The third control area 233 is a more control item configured to pop up more control functions. The electronic paper 30 of the second embodiment displays the first control area 231 on a specific area and triggers the keyboard input by clicks on the first control area 231, which is different from the operation of triggering touch function of the first touch board 81 to move the cursor 210 to the text box 220 as in the first embodiment, thus saving power for the electronic device.

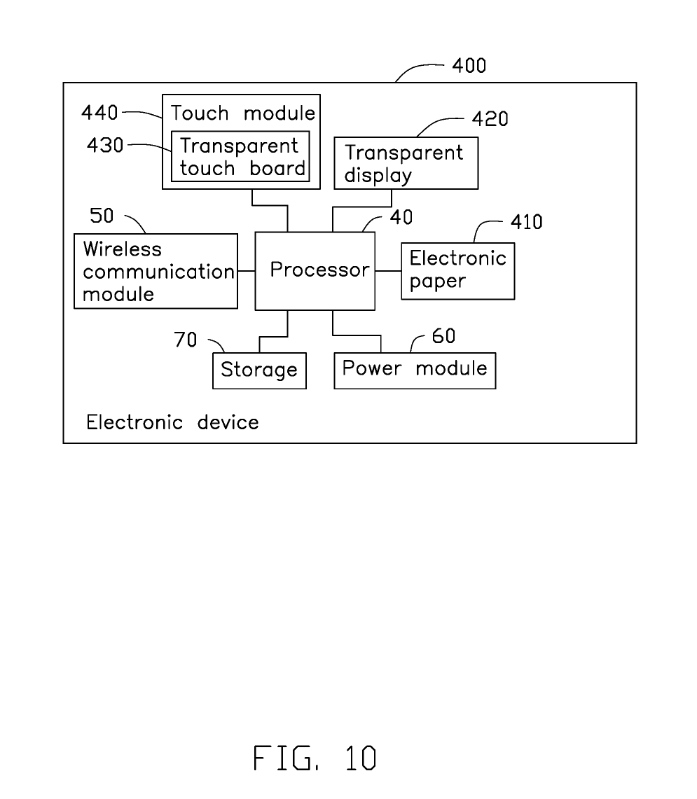

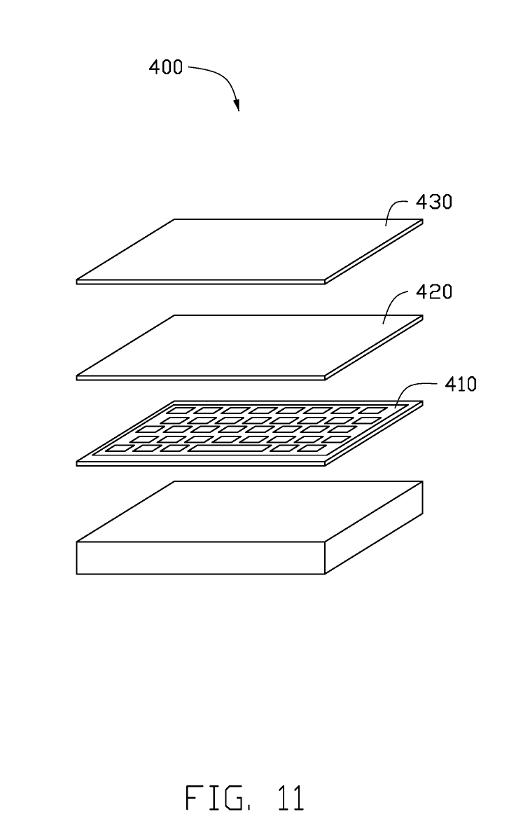

FIGS. 10 and 11 illustrate a fourth type of an electronic device 400. The electronic device 400 includes an electronic paper 410, a transparent display 420, and a touch module 440. The touch module 440 includes a transparent touch board 430 for receiving touch operations. The electronic paper 410, the transparent display 420, and the transparent touch board 430 are overlapped on a same surface of the electronic device 400. The electronic paper 410 is adjacent to the surface of the electronic device 400 and is an innermost layer, the transparent display 420 is between the electronic paper 410 and the transparent touch board 430, and the transparent touch board 430 is an outermost layer. Since the transparent touch board 430 and the transparent display 420 are both transparent material, the electronic paper 410 is visible through the transparent touch board 430 and the transparent display 420 from outside of the electronic device 400. The electronic paper 410 displays a virtual keyboard for receiving input operations from the user. The virtual keyboard displayed by the electronic paper 410 stays still when it is not activated. The transparent display 420 displays a user interface. The transparent touch board 430 receives touch operations from the user. When the electronic device 400 is electrically connected to the external display 200, the transparent touch board 430 receives touch operations from the user, and the transparent display 420 is turned off or blank for saving power. The processor 40 receives the touch operations from the transparent touch board 430 and transmits corresponding signals to the external display 200 to drive the cursor 210. When the cursor 210 moves to the text box 220 and selects the text box 220 by a click operation, the electronic paper 410 is triggered to display the virtual keyboard for receiving input operations.

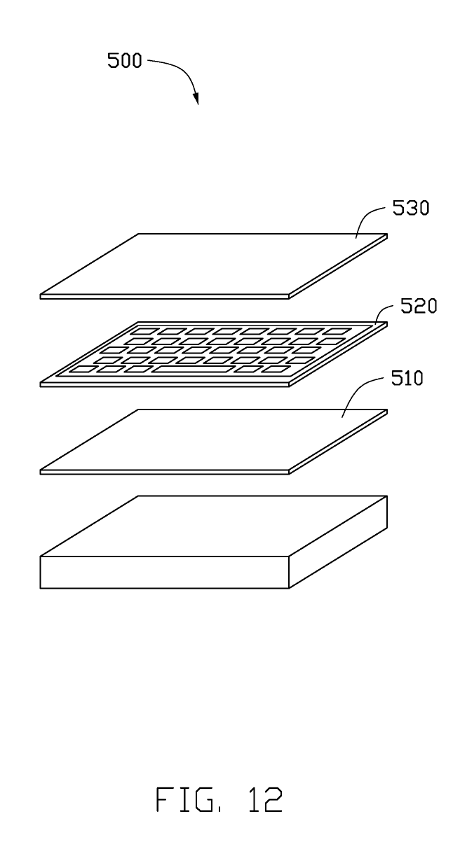

FIG. 12 illustrates a fifth type of an electronic device 500. The electronic device 500 includes a display 510, a transparent electronic paper 520, and a transparent touch board 530. The display 510, the transparent electronic paper 520, and the transparent touch board 530 are overlapped on a same surface of the electronic device 500. The display 510 is adjacent to the surface of the electronic device 500 and is an innermost layer, the transparent electronic paper 520 is between the display 510 and the transparent touch board 530, and the transparent touch board 530 is an outermost layer. Since the transparent touch board 530 and the transparent electronic paper 520 both are transparent material, the display 510 is visible through the transparent touch board 530 and the transparent electronic paper 520 from outside of the electronic device 500.

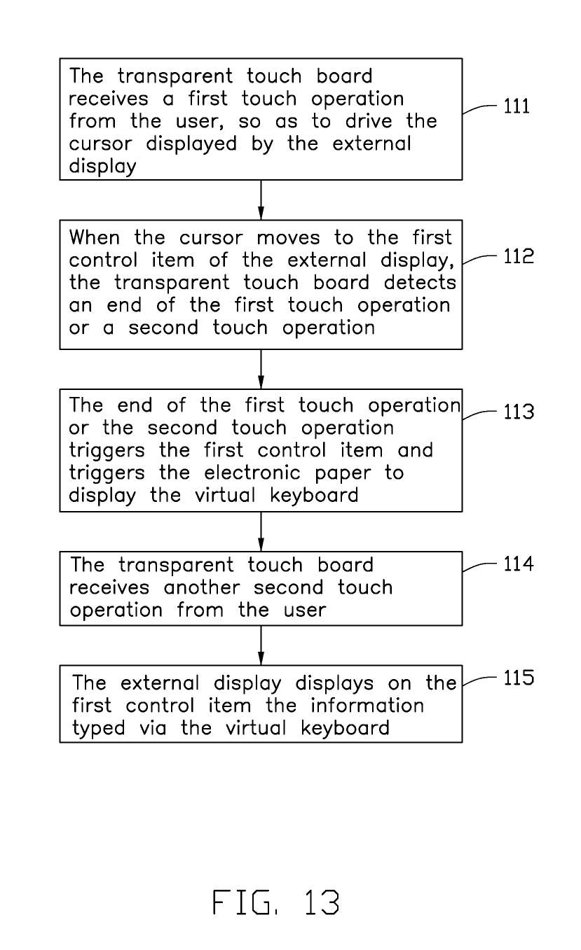

Referring to FIG. 13, a flowchart is presented in accordance with a third embodiment of an operating method of the electronic device 400, 500 connected to the external display 200.

At block 111, the transparent touch board 430, 530 receives a first touch operation from the user, so as to drive the cursor 210 displayed by the external display 200. The processor 40 and the wireless communication module 50 transmit the first touch operation to the external display 200 to drive the cursor 210. The virtual keyboard displayed by the electronic paper 410, 520 stays still, is set to be inactive, and does not receive any input operation before the first control item is triggered; and the virtual keyboard is activated and receives input operations after the first control item is triggered.

At block 112, when the cursor 210 moves to the first control item of the external display 200, the transparent touch board 430, 530 detects an end of the first touch operation or a second touch operation. In at least one embodiment, the first control item is a text box 220. The first touch operation includes at least one movement on the transparent touch board 430, 530 by fingers of the user or a stylus held by the user. In one embodiment, the end of the first touch operation means the finger or the stylus leaves the transparent touch board 430, 530. The second touch operation includes at least one click on the transparent touch board 430, 530.

At block 113, the end of the first touch operation or the second touch operation triggers the first control item and triggers the electronic paper 410, 520 to display the virtual keyboard.

At block 114, the transparent touch board 430, 530 receives another second touch operation from the user. The another second touch operation includes typing on the virtual keyboard displayed by the transparent touch board 430, 530 for inputting information.

At block 115, the external display 200 displays on the first control item the information typed via the virtual keyboard.

Referring to FIG. 8, the electronic paper 410, 520 of the fourth and fifth types of the electronic device 400, 500 may further includes a second control item. Specifically, the second control item includes a first control area 231, a second control area 232, and a third control area 233. The first control area 231 is an input control item.

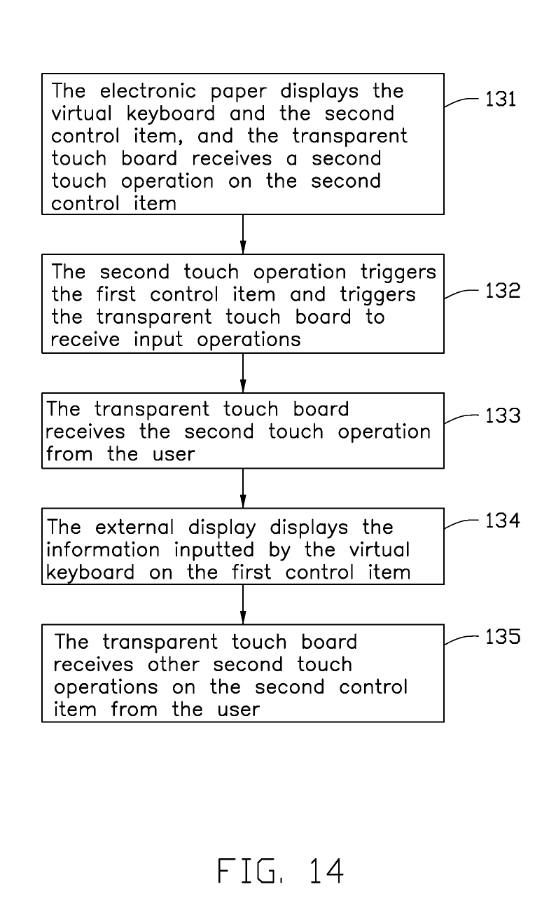

Referring to FIG. 14, a flowchart is presented in accordance with a fourth embodiment of an operating method of the electronic device 400, 500 connected to the external display 200.

At block 131, the electronic paper 410, 520 displays the virtual keyboard and the second control item, and the transparent touch board 430, 530 receives a second touch operation on the second control item. In at least one embodiment, the second touch operation includes at least one click on the first control area 231.

At block 132, the second touch operation triggers the first control item and triggers the transparent touch board 430, 530 to receive input operations.

At block 133, the transparent touch board 430, 530 receives the second touch operation from the user. The second touch operation includes at least one input on the virtual keyboard displayed by the transparent touch board 430, 530 for inputting information.

At block 134, the external display 200 displays the information inputted by the virtual keyboard on the first control item. In at least one embodiment, after the information on the first control item is input, a key of “Esc” or a key of “Enter” on the virtual keyboard can be clicked to leave the first control item.

At block 135, the transparent touch board 430, 530 receives other second touch operations on the second control item from the user. The transparent touch board 430, 530 receives the other second touch operations on the first control area 231, the second control area 232, and the third control area 233. The other second touch operations include clicks on the transparent touch board 430, 530.

In at least one embodiment, when the electronic device 100, 300, 350, 400, 500 is electrically connected to the external display 200, the display 20, 510 and the transparent display 420 may be turned on or blank according to user's selection.

The electronic devices 100, 300, 350, 400, 500 are electrically connected to the external display 200, the external display 200 displays the user interface of the electronic device, and the electronic device includes a touch board for receiving touch operations and an electronic paper for displaying a virtual keyboard and for receiving input operations. Therefore, the electronic devices 100, 300, 350, 400, 500 may present better display effect through the external display 200 and provide users with a better experience of using multiple displays.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. An electronic device capable of being wirelessly connected with an external display, comprising:
an electronic paper; and
a touch module configured to receive at least one touch operation to trigger the external display to display a first control item and the electronic paper to display a virtual keyboard;
wherein the touch module receives input operations through the virtual keyboard and controls the external display to display information corresponding to the input operations on the first control item.

2. The electronic device as claimed in claim 1, wherein the electronic device comprises a display, a first surface and a second surface, and the display and the electronic paper are arranged on the first surface and the second surface, respectively; when the electronic device is not in communication with the external display, the display is turned on and displays a user interface of the electronic device; when the electronic device establishes a wireless communication with the external display, the display is turned off.

3. The electronic device as claimed in claim 2, further comprising a case, wherein the case comprises the second surface and the electronic paper.

4. The electronic device as claimed in claim 2, wherein the touch module comprises a first touch board and a second touch board, the first touch board combines the display to form a touch display, and the second touch board combines the electronic paper to form a touch electronic paper.

5. The electronic device as claimed in claim 4, wherein the at least one touch operation comprises a first touch operation and a second touch operation, the first touch board receives the first touch operation to drive a cursor displayed by the external display to move to the first control item, and the second touch board receives the second touch operation to trigger the first control item.

6. The electronic device as claimed in claim 5, wherein the first touch operation includes at least one movement detected by the first touch board, and the second touch operation includes at least one click detected by the second touch board.

7. The electronic device as claimed in claim 4, wherein the first touch board is configured to be inactivate, the second touch board is configured to receive the at least one touch operation to trigger the first control item, and the at least one touch operation includes at least one click on a second control item displayed on the electronic paper.

8. The electronic device as claimed in claim 1, further comprising a display, wherein the touch module comprises a touch board, the touch board is a transparent touch board and receives the at least one touch operation, the display and the electronic paper are positioned between the touch board and one surface of the electronic device.

9. The electronic device as claimed in claim 8, wherein the electronic paper is positioned between the display and the surface of the electronic device, and the display is a transparent display.

10. The electronic device as claimed in claim 8, wherein the display is between the electronic paper and the surface of the electronic device, and the electronic paper is a transparent electronic paper.

11. The electronic device as claimed in claim 8, wherein the at least one touch operation comprises a first touch operation and a second touch operation, the touch board receives the first touch operation to drive a cursor displayed by the external display to move to the first control item, and the touch board detects an end of the first touch operation or the second touch operation to trigger the first control item.

12. The electronic device as claimed in claim 11, wherein the first touch operation includes at least one movement detected by the touch board, the end of the first touch operation is defined as the movement leaving the touch board, and the second touch operation includes at least one click on the touch board.

13. The electronic device as claimed in claim 8, wherein the touch board receives the touch operations to trigger the first control item, and the touch operations include clicks on a second control item displayed by the electronic paper.

14. The electronic device as claimed in claim 1, wherein the virtual keyboard is set to be inactive before the first control item is triggered; and the virtual keyboard is activated and receives the input operations after the first control item is triggered.

15. An operating method of an electronic device having an electronic paper and being capable of being wirelessly connected with an external display, the operating method comprising:
receiving at least one touch operation to trigger the external display to display a first control item and the electronic paper to display a virtual keyboard; and
receiving input operations through the virtual keyboard and controlling the external display to display information corresponding to the input operations on the first control item.

16. The operating method as claimed in claim 15, further comprising
turning on a display of the electronic device to display a user interface when the electronic device is not in communication with the external display; and
turning off the display when the electronic device establishes a wireless communication with the external display.

17. The operating method as claimed in claim 15, wherein the at least one touch operation comprises a first touch operation and a second touch operation, the electronic device receives the first touch operation to drive a cursor displayed by the external display to the first control item, and the electronic device receives the second touch operation to trigger the first control item.

18. The operating method as claimed in claim 17, wherein electronic device comprises a touch module, and the first touch operation includes at least one movement detected by the touch module, and the second touch operation includes at least one movement leaving or at least one click on the touch module.

19. The operating method as claimed in claim 15, wherein the at least one touch operation includes at least one click on a second control item displayed by the electronic paper.

20. The operating method as claimed in claim 15, wherein the virtual keyboard is set to be inactive before the first control item is triggered; and the virtual keyboard is activated and receives the input operations after the first control item is triggered.
